(19) United States
(12) Patent Application Publication
(10) Pub. No.: US 2013/0081997 A1
(43) Pub. Date: Apr. 4, 2013

(54) SEPARATION MEMBRANE FOR SEAWATER DESALINATION PRETREATMENT, SEAWATER DESALINATION PRETREATMENT DEVICE, SEAWATER DESALINATION APPARATUS, AND SEAWATER DESALINATION METHOD

(71) Applicants: Hideki KASHIHARA, Osaka (JP); Satoshi Yahagi, Osaka (JP); Shuji Hahakura, Osaka (JP)

(72) Inventors: Hideki KASHIHARA, Osaka (JP); Satoshi Yahagi, Osaka (JP); Shuji Hahakura, Osaka (JP)

(73) Assignee: SUMITOMO ELECTRIC INDUSTRIES, LTD., Osaka-shi (JP)

(21) Appl. No.: 13/252,444

(22) Filed: Oct. 4, 2011

(51) Int. Cl. B01D 61/16; B01D 39/16; C02F 1/44; B01D 61/04; B01D 29/00; B01D 63/00; C02F 103/08

(52) U.S. Cl. 210/641; 210/348; 210/500.1; 210/295; 210/259

(57) ABSTRACT

The separation membrane for seawater desalination pretreatment is a separation membrane for seawater desalination pretreatment used in pretreatment for seawater desalination with a reverse osmosis membrane, wherein a standard flux A is 2 m/d or more, which is defined as a maximum value of a flux that can satisfy P2≦1.5×P1 where P1 and P2 represent an average intermembrane differential pressure, and a saccharide removal rate B or a granular carbon removal rate C expressed by a prescribed equation is 0.3 or more, and desirably 0.5 or more.

### TECHNICAL FIELD

The present invention relates to a separation membrane for seawater desalination pretreatment capable of effectively removing suspended substances in seawater, a seawater desalination pretreatment device, a seawater desalination apparatus, and a seawater desalination method.

### BACKGROUND ART

One of the methods for seawater desalination treatment is a method for applying pressure to seawater and passing the seawater through a reverse osmosis membrane (RO membrane) to desalt the seawater and obtain fresh water. This reverse osmosis membrane is a semipermeable membrane including ultrafine pores each having a diameter of approximately 0.1 to 0.5 nm, and has the property of allowing selective passage of only water molecules and not allowing passage of impurities such as salt.

In many cases, however, seawater, which is raw water, includes suspended substances formed of coarse particles. Thus, in order to prevent contamination of the reverse osmosis membrane caused by these suspended substances, pretreatment for removing the suspended substances from the raw water is typically performed before treatment with the reverse osmosis membrane.

Examples of this pretreatment include sand filtration, filtration using a membrane having pores larger than the pores of the reverse osmosis membrane, e.g., microfiltration (MF) or ultrafiltration (UF), a combination thereof, and the like (Non Patent Literature 1).

Microfiltration refers to a method for removing suspended substances by passing raw water through a microfiltration membrane (MF membrane) having a pore diameter of approximately 100 to 1000 nm. Ultrafiltration refers to a method for removing suspended substances by passing raw water through an ultrafiltration membrane (UF membrane) having a pore diameter of approximately 1 to 100 nm.

### CITATION LIST

### Non Patent Literature

NPL 1: Fukuoka District Waterworks Agency, “Mechanism of Desalination,” [online], [searched on Jun. 7, 2010], Internet <URL:http://www.fsuiki.or.jp/seawater/facilities/mechanism.php>

### SUMMARY OF INVENTION

### Technical Problem

In seawater, there is approximately 1 to several ppm of adhesive substances called TEP (transparent exopolymer particles), which are secreted outside a cell by plankton and microbes. TEP contain saccharide as the main ingredient, and are jelly-like particles each having a particle size of approximately 1 to 200 which take water into a cross-linked polymer and swell a hundred fold in terms of volume. The inventors of the present invention found that when the seawater is filtered using the MF membrane or UF membrane, the TEP adhere to the membrane surface and spread out, which causes fouling (clogging) of the MF membrane or UF membrane. As fouling increases, flux (amount of filtration per unit area and unit time) decreases rapidly.

Therefore, the inventors of the present invention is considering, for example, removing the TEP in advance using a filtration membrane (LF membrane) having an average pore diameter of 1 μm or more, prior to filtration with the MF membrane or UF membrane. In this LF membrane as well, the flux may decrease in an early stage due to occurrence of fouling as described above, and thus, the LF membrane does not necessarily suffice.

In other words, there is a negative correlation between the rate of removal of the TEP and the flux in the conventional pretreatment, and if the removal rate is increased, fouling occurs in a shorter time, which causes a rapid decrease in the flux. Therefore, the raw water having the TEP removed therefrom is supplied to the RO membrane in a constant manner at a flux kept fixed by increasing the pressure in accordance with the decrease in the flux.

However, when the pressure is increased, cleaning of the membrane with chemicals and the like becomes necessary, which leads to an increase in cost. When clogging occurs, recovery by cleaning cannot be expected and replacement of the membrane becomes necessary, which leads to an increase in maintenance cost. In addition, when the flux decreases, a large membrane area becomes necessary, which leads to an increase in facilities cost. Furthermore, a more powerful pump is required to increase the pressure, which causes extra facilities cost. In terms of the pressure resistance of the membrane as well, there is a limit to increasing the pressure.

Thus, an object of the present invention is to provide a separation membrane for seawater desalination pretreatment capable of supplying an adequate amount of raw water to an RO membrane in a constant manner with a flux maintained high and without greatly increasing a pressure, while removing TEP at a high removal rate. The object of the present invention is to further provide a seawater desalination pretreatment device and a seawater desalination method.

### Solution to Problem

The inventors of the present invention conducted various experiments and reviews in search for a membrane material capable of reliably capturing TEP, taking into consideration the fact that, although a porous body having communicating pores is used as a conventional separation membrane for pretreatment to capture TEP having a diameter larger than a pore diameter of the communicating pores, the pores are clogged simultaneously with capturing and fouling occurs, which causes a decrease in flux.

As a result, it turned out that polytetrafluoroethylene (PTFE) is suitable as this membrane material. Specifically, since PTFE is a porous body having a large pore formed by masses of resin distributed in the form of islands and a fibrillar structure in which minute fibers are incorporated between these masses of resin, a sufficient flux can be ensured because of the larger pore diameter. Even if the pore diameter is larger than the diameter of the TEP, the incorporated minute fibers can capture the TEP.

Next, the inventors of the present invention evaluated the membrane material with specific numeric values, using a standard flux A described below as an index related to ensuring of the flux as well as a saccharide removal rate B described below as an index related to the rate of removal of the TEP.

Standard flux A refers to a maximum value of the flux that can satisfy P2≦1.5×P1 where P1 represents an average intermembrane differential pressure for initial 30 minutes and P2 represents an average intermembrane differential pressure for 30 minutes after a lapse of 120 minutes, when filtration is performed at a fixed flux.

Saccharide removal rate B is used as the index related to the rate of removal of the TEP because the TEP are jelly-like particles containing saccharide as the main ingredient. Saccharide removal rate B is obtained from the following equation:

saccharide removal rate B=(1−amount of saccharide in filtered water/amount of saccharide in raw water).

In the above calculation of saccharide removal rate B, the amount of saccharide is obtained by quantitatively analyzing and totaling an amount of saccharide for each organic substance in water. However, there are enormous types of organic substances in water. Therefore, as a simpler method for collectively measuring the organic substances in water, the inventors of the present invention focused attention on TOC (Total Organic Carbon) obtained by measuring the organic substances in water in terms of a total amount of organic carbon (amount of carbon).

The inventors of the present invention found that a granular carbon removal rate C, which is obtained from the following equation based on each POC obtained by measuring TOC and DOC (Dissolved Organic Carbon) in each of the raw water and the filtered water with a TOC analyzer and obtaining POC (Particulate Organic Carbon, granular carbon) as a difference between TOC and DOC, is useful as the index related to the rate of removal of the TEP instead of above-mentioned saccharide removal rate B.

granular carbon removal rate C=(1−POC in filtered water/POC in raw water)

The inventors of the present invention conducted various experiments and reviews for each index as described above. As a result, it turned out that the use of a membrane material in which standard flux A is 2 m/d or more and saccharide removal rate B or granular carbon removal rate C is 0.3 or more, and desirably 0.5 or more allows ensuring of a sufficient flux and removal of the TEP at a high removal rate.

It is to be noted that m/d refers to the filtration flow rate (m³) a day per unit membrane area (1 m²).

Evaluation was carried out on the above-mentioned PTFE based on each index as described above. As a result, it was confirmed that standard flux A is approximately 1.5 m/d in the conventional membrane material, whereas standard flux A is 2 m/d or more in the PTFE. This clearly shows that the PTFE is numerically superior to the conventional membrane material. In addition, as for saccharide removal rate B and granular carbon removal rate C as well, it was confirmed that the PTFE shows a removal rate of 0.4 or more, which cannot be obtained in the conventional membrane material. This also clearly shows that the PTFE is numerically superior to the conventional membrane material.

As described above, the use of the membrane material in which standard flux A is 2 m/d or more and saccharide removal rate B or granular carbon removal rate C is 0.3 or more, and desirably 0.5 or more allows ensuring of a sufficient flux and removal of the TEP at a high removal rate.

The above-mentioned evaluation results are not limited to the PTFE membrane material. Similar evaluation results can probably be obtained as long as the membrane material is the porous body having the large pore and the fibrillar structure.

Furthermore, it turned out that when a value obtained by multiplying standard flux A by saccharide removal rate B or granular carbon removal rate C as described above is used as an index and when this value is 2 or more, the effect becomes synergistic and very excellent pretreatment can be performed. The PTFE satisfies this value as well. The value is more preferably 5 or more, and further preferably 10 or more.

The invention claimed in claims 1 to 18 is based on these findings. Specifically, the invention claimed in claim 1 is directed to a separation membrane for seawater desalination pretreatment used in pretreatment for seawater desalination with a reverse osmosis membrane, wherein

a standard flux A is 2 m/d or more, which is defined as a maximum value of a flux that can satisfy P2≦1.5×P1 where P1 represents an average intermembrane differential pressure for initial 30 minutes and P2 represents an average intermembrane differential pressure for 30 minutes after a lapse of 120 minutes, when filtration is performed at a fixed flux, and

a saccharide removal rate B expressed by a following equation is 0.3 or more:

saccharide removal rate B=(1−amount of saccharide in filtered water/amount of saccharide in raw water).

The invention claimed in claim 2 is directed to the separation membrane for seawater desalination pretreatment according to claim 1, wherein the saccharide removal rate B is 0.5 or more.

In addition, the invention claimed in claim 10 is directed to a separation membrane for seawater desalination pretreatment used in pretreatment for seawater desalination with a reverse osmosis membrane, wherein a standard flux A is 2 m/d or more, which is defined as a maximum value of a flux that can satisfy P2≦1.5×P1 where P1 represents an average intermembrane differential pressure for initial 30 minutes and P2 represents an average intermembrane differential pressure for 30 minutes after a lapse of 120 minutes, when filtration is performed at a fixed flux, and

a granular carbon removal rate C expressed by a following equation is 0.3 or more:

granular carbon removal rate C=(1−POC in filtered water/POC in raw water)

where POC refers to an amount of particulate organic carbon (a difference between an amount of total organic carbon and an amount of dissolved organic carbon).

The invention claimed in claim 11 is directed to the separation membrane for seawater desalination pretreatment according to claim 10, wherein the granular carbon removal rate C is 0.5 or more.

The invention claimed in claims 3 and 12 is directed to the separation membrane for seawater desalination pretreatment according to claims 1 and 10, wherein the separation membrane for seawater desalination pretreatment is made of polytetrafluoroethylene.

The invention claimed in claims 4 and 13 is directed to the separation membrane for seawater desalination pretreatment according to claims 1 and 10, wherein the separation membrane for seawater desalination pretreatment has a pore diameter of 1 μm or more.

In the present invention, an LF membrane having a pore diameter of 1 μm or more is preferably used. The pore diameter of the membrane herein is indicated by an average pore diameter. The average pore diameter refers to the pore diameter determined by the bubble point method (airflow method).

Specifically, this pore diameter refers to diameter d (μm) expressed by the following equation, assuming that P (Pa) represents an IPA bubble point value (pressure) measured based on ASTM F316 by using isopropyl alcohol, γ represents the surface tension (dynes/cm) of the liquid, and B represents the capillary constant. It is to be noted that the same is also applied to the average pore diameter of the MF membrane, the UF membrane or the like.

d=4Bγ/P

Since the LF membrane has an average pore diameter of 1 μm or more, the flow rate (flux) per unit membrane area can be increased. Conversely, a desired amount of treatment can be obtained with smaller facilities. The smaller the average pore diameter of the LF membrane is, the smaller particles can be removed, and the rate of removal of the suspended substances and the organic particles such as TEP in the pretreatment is enhanced. On the other hand, the smaller the average pore diameter of the LF membrane is, the smaller the flow rate (flux) per unit membrane area is. Accordingly, the optimum pore diameter is selected in consideration of the flow rate (flux) per unit membrane area as well as the desired rate of removal of the suspended substances and the organic particles such as TEP.

The invention claimed in claims 5 and 14 is directed to the separation membrane for seawater desalination pretreatment according to claims 1 and 10, wherein the separation membrane for seawater desalination pretreatment is not subjected to hydrophilicizing processing.

When the membrane is a polymer membrane (hydrophobic polymer membrane) made of a hydrophobic material such as the PTFE membrane, hydrophilicizing processing is generally performed using, for example, a method for cross-linking the surface of the PTFE membrane with a hydrophilicizing compound such as vinyl alcohol, in order to increase the compatibility with the liquid to be treated.

The inventors of the present invention, however, found that a high flux and a high saccharide removal rate or granular carbon removal rate can be ensured when the membrane is used as the separation membrane for pretreatment, because the membrane is not subjected to hydrophilicizing processing in which a hydrophilic material is cross-linked and fixed onto the membrane surface.

Unlike the aforementioned processing, it is preferable to perform hydrophilicizing treatment using a method for bringing the membrane into contact with hydrophilic alcohol and covering the surface of the membrane (including the inside of the pores) with the hydrophilic alcohol before passing the liquid to be treated through the membrane. The hydrophilic alcohol can include ethanol, propanol and the like, and isopropanol, in particular, is preferably used.

The invention claimed in claims 6 and 15 is directed to a seawater desalination pretreatment device, wherein the separation membrane for seawater desalination pretreatment as recited in claims 1 and 10 is used as a filtration membrane.

Since the separation membrane for seawater desalination pretreatment capable of sufficiently removing the organic substances and sufficiently suppressing a decrease in the flux, an adequate amount of raw water having the organic substances removed therefrom can be fed to a seawater desalination apparatus in a stable manner.

The invention claimed in claims 7 and 16 is directed to the seawater desalination pretreatment device according to claims 6 and 15, wherein pretreatment means in which a microfiltration membrane or ultrafiltration membrane is used is provided after pretreatment means in which the separation membrane for seawater desalination pretreatment as recited in claims 1 and 10 is used.

By further arranging the microfiltration membrane or ultrafiltration membrane having a smaller pore diameter, there can be provided a seawater desalination pretreatment device with excellent filtration property capable of further removing fine suspended substances other than the organic substances removed by the above-mentioned separation membrane for seawater desalination pretreatment.

The invention claimed in claims 8 and 17 is directed to a seawater desalination apparatus, including: the seawater desalination pretreatment device as recited in claims 6 and 15; and a desalting treatment device in which a reverse osmosis membrane is used.

The use of the seawater desalination pretreatment device with excellent filtration property allows supply of the raw water having the organic substances sufficiently removed therefrom. Therefore, there can be provided a seawater desalination apparatus in which occurrence of fouling at the RO membrane is suppressed even when desalting treatment is performed over a long time period using the desalting treatment device in which the reverse osmosis membrane is used.

The invention claimed in claims 9 and 18 is directed to a seawater desalination method, wherein raw water filtered using the seawater desalination pretreatment device as recited in claims 6 and 15 is desalted using a reverse osmosis membrane method.

Desalting treatment is performed on the raw water having the organic substances sufficiently removed therefrom. Therefore, occurrence of fouling at the RO membrane is suppressed even when desalting treatment is performed over a long time period.

### Advantageous Effects of Invention

According to the present invention, an adequate amount of raw water can be supplied to the RO membrane in a constant manner with the flux maintained high and without increasing the pressure, while removing the TEP at a high removal rate.

### BRIEF DESCRIPTION OF DRAWINGS

FIG. 1(a) is a schematic view of a separation membrane according to the present embodiment as viewed two dimensionally.

FIG. 1(b) is a schematic view showing a manner of capturing a jelly-like object M by a structure of joint portions and fine fibers.

FIG. 2 is a block diagram showing a configuration of a seawater desalination apparatus including a pretreatment device in which the separation membrane according to the present invention is used.

### DESCRIPTION OF EMBODIMENTS

The present invention will be described hereinafter based on an embodiment with reference to the drawings.

1. Separation Membrane

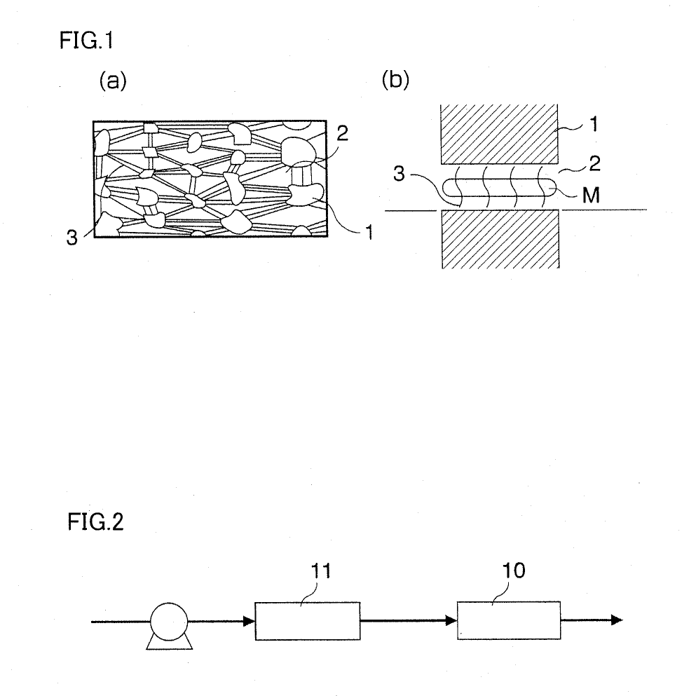

First, a separation membrane for seawater desalination pretreatment according to the present embodiment will be described. FIG. 1 is a view for describing the separation membrane according to the present embodiment. FIG. 1(a) is a schematic view of the separation membrane as viewed two dimensionally.

The separation membrane according to the present embodiment is a porous membrane made of PTFE. As shown in FIG. 1(a), the separation membrane according to the present embodiment is formed of multiple joint portions 1 and multiple fine fibers (fibrils) 3 each having a thickness of 1 μm or less and linking joint portions 1. Multiple pores 2 are formed between joint portions 1.

FIG. 1(b) is a schematic view showing a manner of capturing a jelly-like object M by the structure of joint portions 1 and fine fibers 3. Since fine fibers 3 exist in an irregularly intricate manner in the planar direction and in the thickness direction, fine fibers 3 can reliably capture jelly-like carbon containing saccharide as the main ingredient in the entire thickness direction of the membrane even if each pore 2 has a large pore diameter. By removing the jelly-like carbon, all carbon (TOC), in particular granular carbon (POC) in raw water decreases. As a result, the saccharide can be filtered at a high removal rate, while maintaining a flux of 5 m/d higher than a flux of approximately 1.5 m/d in a conventional separation membrane.

2. Measurement of Flux

Standard flux A is used as the flux, which is defined as a maximum value of a flux that can satisfy P2≦1.5×P1 where P1 represents an average intermembrane differential pressure for initial 30 minutes and P2 represents an average intermembrane differential pressure for 30 minutes after a lapse of 120 minutes, when filtration is performed at a fixed flux.

3. Measurement of Removal Rate

Next, a method for measuring a removal rate will be described. Although the removal rate is generally evaluated with the saccharide removal rate, the removal rate can also be evaluated with the granular carbon removal rate instead of the saccharide removal rate for the sake of simplicity of measurement.

(1) Saccharide Removal Rate

The saccharide removal rate is expressed by the following equation:

saccharide removal rate=1−amount of saccharide in filtered water/amount of saccharide in raw water.

The amount of saccharide in the filtered water and the amount of saccharide in the raw water are measured through saccharide analysis.

Specifically, various types of saccharides in water are quantitatively analyzed using a saccharide analyzer, e.g., a saccharide analyzer ICS-3000 with an electrochemical detector manufactured by Nippon Dionex K.K., and a total sum thereof is expressed in ppm.

(2) Granular Carbon Removal Rate

The granular carbon removal rate is expressed by the following equation:

granular carbon removal rate=1−POC in filtered water/POC in raw water.

POC in the filtered water and in the raw water is calculated in accordance with the following procedure:

I. measure TOC in a sample (raw water and filtered water) using the TOC analyzer

II. filter the sample using a filter having a pore diameter of 0.1 μm (as a result, POC is totally removed and only DOC is left in the filtered water)

III. measure DOC included in the filtered water using the TOC analyzer

IV. calculate POC from measured TOC and DOC in accordance with the following equation:

POC=TOC−DOC

In the above, TOC represents a total amount of carbon (Total Organic Carbon) in organic compounds existing in the raw water. DOC represents an amount of carbon (Dissolved Organic Carbon) in organic compounds existing in the filtered water. POC represents removed granular carbon (Particulate Organic Carbon).

It is to be noted that TOC is measured using a combustion oxidation non-dispersive infrared absorption scheme. Specifically, using a platinum catalyst, organic substances are burned with highly-pure air or oxygen at a high temperature. The concentration of carbon dioxide generated as a result of combustion is measured using a gas analyzer to measure TOC. TOC-Vc series manufactured by Shimadzu Corporation is, for example, used as the TOC analyzer.

4. Seawater Desalination Apparatus

Next, a seawater desalination apparatus will be described. A seawater desalination apparatus shown in FIG. 2 is configured by a pretreatment device 11 and a desalter 10 desalting pretreated seawater. An arrow in the figure indicates a flow of water to be treated, and a pump is arranged in the former stage of pretreatment device 11.

(1) Pretreatment Device

Pretreatment device 11 includes the separation membrane having the above-mentioned configuration. The pretreatment device may be configured by one-stage filtration only with the above-mentioned separation membrane, or by two-stage filtration using a first pretreatment device including the separation membrane having the above-mentioned configuration and a second pretreatment device performing ultrafiltration with the UF membrane or microfiltration with the MF membrane. Even the one-stage filtration is effective in that the one-stage filtration has an effect of sufficiently removing saccharide and the membrane area of the entire pretreatment device can be reduced. The two-stage filtration, however, allows further enhancement of the degree of filtration of substances including other substances to be removed.

(2) Desalter

Desalter 10 includes a reverse osmosis membrane having a pore diameter of approximately 1 to 2 nm. Although desalter 10 may be configured by a spiral-type or tubular-type reverse osmosis membrane or by a hollow fiber membrane, desalter 10 must be configured to treat a large amount of seawater.

In the seawater desalination apparatus configured as described above, pretreatment device 11 first pretreats seawater by passing the seawater through the above-mentioned separation membrane, to filter and remove organic suspended substances and inorganic solid substances in the seawater. Then, the seawater having the organic suspended substances and the inorganic solid substances removed therefrom by pretreatment device 11 passes through desalter 10, where the seawater is desalted to obtain fresh water.

When the abilities of pretreatment device 11 and desalter 10 decrease due to long-term operation, backwashing is done to recover the abilities, and thus, pretreatment device 11 and desalter 10 can be repeatedly used for seawater desalting treatment.

Seawater desalination pretreatment device 11 in which the separation membrane according to the present invention is used filters and removes the organic suspended substances and the inorganic solid substances in the seawater by passing the seawater through the above-mentioned separation membrane. Therefore, clogging in the desalter can be effectively prevented, and reduction in size of the desalter becomes possible. In addition, desalting cost can be reduced.

### EXAMPLE

The pretreatment device in which the separation membrane according to the present invention is used will be described hereinafter based on examples.

### Example 1

In the present example, the separation membrane is evaluated using the granular carbon removal rate.

1. Filtration

Seawater, which was raw water, was filtered using a pretreatment device of a hydrophilic TT type including the separation membrane according to the present invention. The hydrophilic TT type herein refers to a treatment scheme in which a membrane having a fibrillar structure used in the present invention is used. A membrane (LF membrane made of PTFE) obtained by cross-linking and fixing a hydrophilic polymer onto a surface thereof and performing hydrophilicizing processing is called “hydrophilic TT membrane,” and TT is an acronym for “TEP Trap.” “Hydrophobic TT type” as described later refers to a scheme in which a hydrophobic membrane that is not subjected to hydrophilicizing processing is used (hydrophilicizing treatment with alcohol is performed first).

(1) Hollow Fiber Module

A hollow fiber membrane module provided with a hollow fiber membrane (POREFLON (registered trademark) type: TBW-2311-200) made of PTFE and having a fibrillar structure was used. The details of this hollow fiber membrane module is as follows:

standard flux:
10 m/d

| | | |
|---|---|---|
| hollow fiber : | number of hollow fibers | 360 |

| | | |
|---|---|---|
| membrane | effective length | 1000 mm |

| | |
|---|---|
| outer diameter of hollow fiber | 2.3 mm |
| inner diameter of hollow fiber | 1.1 mm |

| | |
|---|---|
| thickness of hollow fiber membrane | 600 μm |

| | |
|---|---|
| pore diameter | 2.0 μm (90% or more of average |

particle blocking rate)

| | |
|---|---|
| porosity | 70% |

where porosity=100×{1−(hollow fiber resin volume cc)/(hollow fiber bulk volume cc)}

hollow fiber resin volume=hollow fiber weight g/PTFE density

hollow fiber bulk volume=hollow fiber cross-sectional area cm³×length cm

(2) Filtration Condition

pressure: filtration was performed under a pressure of 50 kPa.

2. Measurement of Flux and Removal Rate

(1) Measurement Method

I. Measurement of Flux

The flux was measured based on an amount of filtered water accumulating in a graduated cylinder for a certain time period.

II. Measurement of Granular Carbon Removal Rate

The granular carbon removal rate was measured using type TOC-Vc manufactured by Shimadzu Corporation, which is a combustion catalyst oxidation-type TOC analyzer (total organic carbon analyzer). It is to be noted that silica, aluminum and iron were also analyzed for reference.

(2) Measurement Result

I. Flux

The flux was 10 m/d.

II. Removal Rate

The measurement result is shown in Table 1.

TABLE 1

concentration (ppm)

| | raw water | hydrophilic TT |
|---|---|---|
| | (seawater) | filtered water |
| TOC | 1.55 | 1.3 |
| DOC | 1.32 | 1.3 |
| POC (TOC − DOC) | 0.23 | 0 |
| silica | 0.71 | 0.68 |
| aluminum | 0.04 | 0.03 |
| iron | 0.05 | 0.00 |

It turns out from Table 1 that POC is removed from 0.23 ppm to 0 ppm, that is, POC is removed at a granular carbon removal rate of 1.0. It is confirmed that silica, aluminum and iron are also removed.

Based on the above, it turns out that the use of the separation membrane for seawater desalination pretreatment according to the present invention allows a higher flux, and further, a higher removal rate.

### Example 2

In the present example, the separation membrane is evaluated using the saccharide removal rate.

1. Filtration

Seawater obtained on the coast of Shizuoka City, Shizuoka Prefecture, which was raw water, was filtered using pretreatment devices of the hydrophilic TT type and the hydrophobic TT type including the separation membrane according to the present invention. It is to be noted that the seawater was filtered using a metal mesh having a 2 μm mesh for comparison. Example 2 is similar to Example 1 except for measurement as described below.

2. Measurement

(1) Measurement of Saccharide Removal Rate

The removal rates of TOC, galactose and glucose were measured through saccharide analysis. Specifically, analysis was performed in accordance with the following procedure:

a. Preparation of Sample

980 mL (milliliter) of the sample was freeze-dried several times and was washed with water to obtain exactly 100 mL of the sample.

b. Hydrolysis

1 mL of the prepared sample was mixed with 1 mL of 4 mol/L trifluoroacetic acid. After sealing a tube under reduced pressure, the mixture was heated at 100° C. for three hours and underwent hydrolysis.

After cooling to room temperature, a solvent was distilled away using a centrifugal evaporator, 1 mL of water was precisely added and an ultrasonic wave was applied.

This solution was put into a filter unit containing an ion-exchange resin (0.45 μm) and was centrifuged (10000 rpm) for one minute. A sample solution was thus obtained.

c. Preparation of Standard Solution

Water was added to 10 mg of arabinose, 10 mg of glucose, 10 mg of galactose, 10 mg of fructose, 10 mg of mannose, and 10 mg of rhamnose to obtain exactly 50 mL of a solution. 5 mL of this solution was precisely extracted and water was added to obtain exactly 50 mL of the solution, which was used as a standard solution. The standard solution was precisely diluted with water, thereby preparing a standard solution 1 (about 0.2 μg/mL), a standard solution 2 (about 1 μg/mL) and a standard solution 3 (about 5 μg/mL).

d. Measurement Condition

saccharide analyzer: ICS-3000 manufactured by Nippon Dionex K.K.

detector: electrochemical detector

column: CarboPacPA10 (4 mm I.D×250 mm)

column temperature: fixed temperature near 25° C.

mobile phase A: 10 mmol/L sodium hydroxide solution

mobile phase B: 200 mmol/L sodium hydroxide solution

The gradient condition is shown in Table 2.

TABLE 2

| | time (minute) | | | | | |
|---|---|---|---|---|---|---|
| | 0 | 40 | 40.01 | 50 | 50.01 | 60 |
| mobile phase A (%) | 100 | 100 | 0 | 0 | 100 | 100 |
| mobile phase B (%) | 0 | 0 | 100 | 100 | 0 | 0 |

flow rate: 1 mL
amount of injection: 25 μL

(2) Measurement Result of Removal Rate

The result is shown in Table 3.

TABLE 3

| | concentration (ppm) | | | |
|---|---|---|---|---|
| | | hydrophilic TT | hydrophobic TT | |
| | seawater | filtration | filtration | metal mesh |
| TOC | 1.6 | — | — | 1.6 |
| galactose | 0.021 | 0.012 | 0.006 | 0.015 |
| glucose | 0.031 | 0.022 | 0.012 | 0.028 |

It turns out from Table 3 that the saccharide removal rate is calculated as described below and more galactose and glucose are removed as compared with the metal mesh.

saccharide removal rate B=(1−amount of saccharide in filtered water/amount of saccharide in raw water)

saccharide in seawater: 0.021+0.031=0.052 ppm

saccharide in hydrophilic TT filtered liquid: 0.012+0.022=0.034 ppm

saccharide in hydrophobic TT filtered liquid: 0.006+0.012=0.018 ppm therefore,

saccharide removal rate B in hydrophilic TT type=(1−0.034/0.052)=0.34

saccharide removal rate B in hydrophobic TT type=(1−0.018/0.052)=0.65

As described above, according to the present invention, the organic suspended substances can be removed with high efficiency, clogging in the desalter can be prevented over a long time period, and cost can be reduced. In addition, the effect turns out to be more profound in the hydrophobic TT type than in the hydrophilic TT type.

Although the present invention has been described in the above based on the embodiment, the present invention is not limited to the above-mentioned embodiment. Various modifications can be made to the above-mentioned embodiment within the scope that is the same as and equivalent to the present invention.

### REFERENCE SIGNS LIST

1 joint portion; 2 pore; 3 fine fiber; 10 desalter; 11 pretreatment device.

1. A separation membrane for seawater desalination pretreatment used in pretreatment for seawater desalination with a reverse osmosis membrane, wherein
a standard flux A is 2 m/d or more, which is defined as a maximum value of a flux that can satisfy P2≦1.5×P1 where P1 represents an average intermembrane differential pressure for initial 30 minutes and P2 represents an average intermembrane differential pressure for 30 minutes after a lapse of 120 minutes, when filtration is performed at a fixed flux, and
a saccharide removal rate B expressed by a following equation is 0.3 or more:
saccharide removal rate B=(1−amount of saccharide in filtered water/amount of saccharide in raw water).

2. The separation membrane for seawater desalination pretreatment according to claim 1, wherein
said saccharide removal rate B is 0.5 or more.

3. The separation membrane for seawater desalination pretreatment according to claim 1, wherein
said separation membrane for seawater desalination pretreatment is made of polytetrafluoroethylene.

4. The separation membrane for seawater desalination pretreatment according to claim 1, wherein
said separation membrane for seawater desalination pretreatment has a pore diameter of 1 μm or more.

5. The separation membrane for seawater desalination pretreatment according to claim 1, wherein
said separation membrane for seawater desalination pretreatment is not subjected to hydrophilicizing processing.

6. A seawater desalination pretreatment device, wherein the separation membrane for seawater desalination pretreatment as recited in claim 1 is used as a filtration membrane.

7. The seawater desalination pretreatment device according to claim 6, wherein
pretreatment means in which a microfiltration membrane or ultrafiltration membrane is used is provided after pretreatment means in which the separation membrane for seawater desalination pretreatment as recited in claim 1 is used.

8. A seawater desalination apparatus, comprising:
the seawater desalination pretreatment device as recited in claim 6; and
a desalting treatment device in which a reverse osmosis membrane is used.

9. A seawater desalination method, wherein raw water filtered using the seawater desalination pretreatment device as recited in claim 6 is desalted using a reverse osmosis membrane method.

10. A separation membrane for seawater desalination pretreatment used in pretreatment for seawater desalination with a reverse osmosis membrane, wherein
a standard flux A is 2 m/d or more, which is defined as a maximum value of a flux that can satisfy P2≦1.5×P1 where P1 represents an average intermembrane differential pressure for initial 30 minutes and P2 represents an average intermembrane differential pressure for 30 minutes after a lapse of 120 minutes, when filtration is performed at a fixed flux, and
a granular carbon removal rate C expressed by a following equation is 0.3 or more:
granular carbon removal rate C=(1−POC in filtered water/POC in raw water)
where POC refers to an amount of particulate organic carbon (a difference between an amount of total organic carbon and an amount of dissolved organic carbon).

11. The separation membrane for seawater desalination pretreatment according to claim 10, wherein
said granular carbon removal rate C is 0.5 or more.

12. The separation membrane for seawater desalination pretreatment according to claim 10, wherein
said separation membrane for seawater desalination pretreatment is made of polytetrafluoroethylene.

13. The separation membrane for seawater desalination pretreatment according to claim 10, wherein
said separation membrane for seawater desalination pretreatment has a pore diameter of 1 μm or more.

14. The separation membrane for seawater desalination pretreatment according to claim 10, wherein
said separation membrane for seawater desalination pretreatment is not subjected to hydrophilicizing processing.

15. A seawater desalination pretreatment device, wherein the separation membrane for seawater desalination pretreatment as recited in claim 10 is used as a filtration membrane.

16. The seawater desalination pretreatment device according to claim 15, wherein
pretreatment means in which a microfiltration membrane or ultrafiltration membrane is used is provided after pretreatment means in which the separation membrane for seawater desalination pretreatment as recited in claim 10 is used.

17. A seawater desalination apparatus, comprising:
the seawater desalination pretreatment device as recited in claim 15; and
a desalting treatment device in which a reverse osmosis membrane is used.

18. A seawater desalination method, wherein
raw water filtered using the seawater desalination pretreatment device as recited in claim 15 is desalted using a reverse osmosis membrane method.
